(19) United States
(12) Patent Application Publication
(10) Pub. No.: US 2014/0018712 A1
(43) Pub. Date: Jan. 16, 2014

(54) VIBRATING MASSAGE TABLE

(71) Applicants: Sarl D'Exploitation, C.M.E., Revin (FR); Chiropractique Attitude, Charleville-Mezieres (FR)

(72) Inventors: Antoine BOUCHET, Charleville-Mezieres (FR); Nicolas PAGEOT, Villers Semeuse (FR)

(21) Appl. No.: 13/934,841

(22) Filed: Jul. 3, 2013

(30) Foreign Application Priority Data
Jul. 6, 2012 (FR) 12 56525

(51) Int. Cl. A61H 23/00

(52) U.S. Cl. CPC A61H 23/00
USPC 601/56

(57) ABSTRACT

The present invention concerns a vibrating massage table (1) comprising at least a foot support (3) on which rests a plate (2) tilting around a central axis (4) and allowing a slope of a patient lying on the aforementioned table (1) so that the feet of the patient are placed on a level higher than his head, the aforementioned plate (2) comprising at least one engine means propagating vibrations and at least one means of restraint (11 a, 11 b) of the patient.

The plate (2) of this vibrating massage table (1) has the particularity to be longitudinally divided into several cross cushions (5, 6, 7, 8, 9, 10) each adapted to a part of the body; in addition, one of these cushions (10) is adapted to the ankles and the feet of the patient, said cushion (10) being activated in vibration by at least one engine means, said vibrations being propagated from ankles and feet to the whole body of the patient.

### CROSS REFERENCE TO RELATED APPLICATIONS

The present Application for Patent claims priority to French Patent Filing Number 12 56525, entitled “VIBRATING MASSAGE TABLE” and filed Jul. 6, 2012, which is expressly incorporated by reference herein.

### TECHNICAL FIELD

The present invention relates to the field of devices intended for therapeutic or relaxation utilization. The present invention will find application mainly in the field of massage beds. However, the application should not be considered restrictive; indeed, the present invention may also be applied in the field of tables designed specifically for relaxation and/or decompression of a patient, e.g. after muscular effort. The invention relates more particularly to a massage table unique in that it can produce vibrations propagating to the entirety of the body of the person placed on the table.

### BACKGROUND

Traditionally, massage tables used by physiotherapists and masseurs have a plate, allowing a person to be placed lying down, and a plurality of legs supporting said plate and resting on the ground. Advantageously, such a massage table comprises means allowing the user to easily fold it up, particularly when it is brought to the residence of the people who are to be massaged. It is also known from the state of the technique to build massage tables with means allowing the distribution of vibrations to the body so as to enable a treatment of the patient who is on the plate.

For this purpose, it is known from document FR-970160, a vibrating table that has a plate divided into different items, which may vibrate independently of each other in order to help a reeducation after trauma or to treat different ailments, like obesity and nervous diseases. Yet we know, from the French patent document FR 1108031 a table combining vibration and mechanical traction to treat a patient. More particularly, the table described in this document can oscillate in a vertical plane about an axis and has a central axis supporting vibrating plates, from which it is possible to change the orientation by twisting and, for a certain tray, the position in translation with respect to the central axis of the table.

We also know, by French patent document FR 1585871 a specific dispositive for mechanical treatment of the spine and bone connections, i.e. including the pelvic ring, girdle scapular, and the occipital area. Specifically, the table described in this document is tilting around an axis and is equipped with a single vibration plate supporting the torso of the patient so that the vibrations are directed upwards and in the direction of the inclination of the vibrating plate. Vibrations can be adjusted in number and amplitude.

However, the solutions proposed in these documents are not optimal and do not allow an effective treatment for the whole body of the patient who is on the table. UK patent document 2270649 is itself relative to a stationary decompression unit that vibrates, and the objective is to allow decompression of the spine from the vibrations. The mechanism of vibration of this device is below the surface of the table, which is tilting. The table, according to this document, is also provided with a dispositive, allowing support of the patient's feet, and support of the patient's head, for example via a chin strap. The tilt of the table leads to an extension of the spine of the patient, with the weight of his body, and the vibrations are applied to a part located at the head of the table, which corresponds to the level where the neck of the patient is situated. Thus, in this document, a single plate, the one at the head of the table, is mobile and transmits vibrations to the body of the patient, which does not allow an optimal treatment of the whole body. In addition, maintaining the patient by the head may be discomforting.

### SUMMARY

This invention offers the possibility to overcome the various drawbacks of the state of the technology by providing a table intended to relax, or treat, the whole body of a patient.

The present invention relates to a vibrating massage table with at least a foot support on which rests a plate tilting around a central axis and allowing tilting of a patient on the said table, so that the feet of the patient are placed on a level higher than the patient's head, said plate having at least one drive means propagating vibrations and at least a means of withholding of the patient.

The particularity of this massage table come from the fact that the plate is divided longitudinally into several transverse cushions, each adapted to a body part, one of the cushions being adapted to the ankles and feet of the patient, said cushion being activated in vibration by at least one drive means, said vibrations being propagated from the ankles and foot to the whole body of the patient.

According to one particularly preferential realization mode, the cushion adapted to the ankles and feet of the patient is divided into two juxtaposed portions, and each comprising at least one retaining means for the patient's ankles and/or feet, said portions being activated with vibration by at least one drive means.

Advantageously, the plate has, in addition of the cushion adapted to ankles and feet of the patient: a first cushion adapted to receive the patient's head and give cervical support; a second cushion adapted to the patient's chest; a third cushion adapted to the patient's lumbar; a fourth cushion adapted to the patient's pelvis and thighs; and a fifth cushion adapted to the calf of the patient.

According to another characteristic of the invention, at least one of the cross cushions is movable from another alongside a longitudinal axis to the plate. Preferentially, at least the first, second, third and fourth cushions are movable from each other by sliding alongside a longitudinal axis to the plate. Favorably, these cushions are movable by sliding alongside a rail situated in the center of the plate of the massage table. Interestingly, the plate still consists of management of the slide with ways to limit the sliding action of the mobile cushions.

The present invention has many advantages. On one hand, the table can be used both for preventive and curative purposes. Indeed, the table can, for example, be used following a physical effort, thus bringing to the patient a releasing effecton the level of the complex neuromuscular skeleton, which includes the nervous system, the skeleton, the muscles and tissues, allowing the maintenance and the connections between the elements of the human body, the cartilage, the tendons and the ligaments.

Moreover, the system of vibrations and supporting cushions placed at the level of the ankles and the feet allow a transmission of short and fast vibrations, which are propagated to the rest of the body from the lower part of the body, allowing a total feeling of relaxation and gentleness.

### BRIEF DESCRIPTION OF THE DRAWINGS

Other characteristics and advantages of the invention will come from the detailed description which will follow of the modes of non-limiting realization of the invention with reference to the accompanying figures in which:

FIG. 1 schematically represents a side view of a realization mode of the massage table according to the invention; and

FIG. 2 is a top view of a realization mode of the massage table according to the invention.

### DETAILED DESCRIPTION

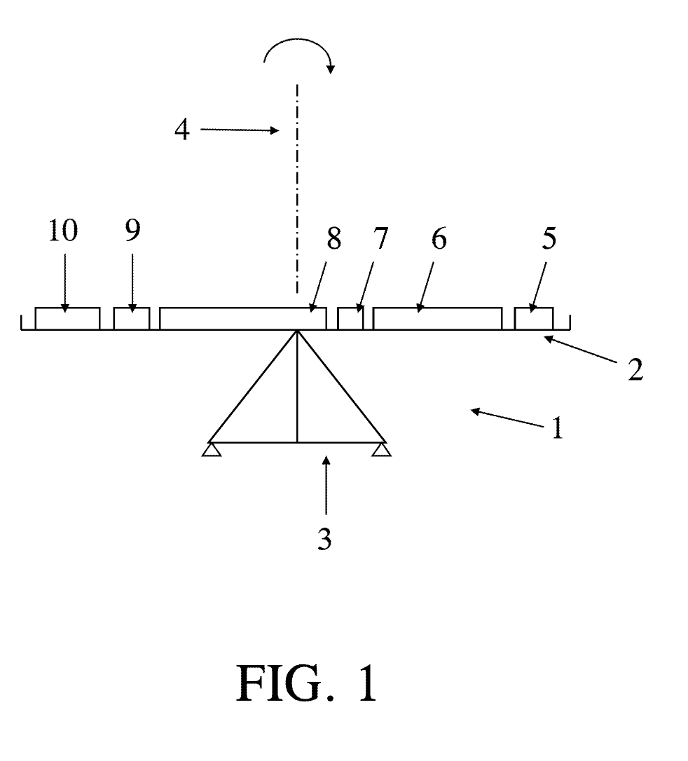

As shown in FIG. 1, the present invention relates to a vibrating massage table 1 that can be used for the good of the patient who stretches over the said table 1, as well as to treat this patient when he feels muscle pain, bone pain, or other pain.

Table 1, according to the invention includes a plate 2 resting on at least one foot 3. Plate 2 of the vibration table is made to tilt up around a central axis 4 and to heel over, allowing a gradual inclination of the body of the patient that is being stretched on the table 1. The mechanism allowing the swing of plate 2 of table 1 can consist of any means known to the specialist of the profession and suited for this purpose.

More preferentially, such a mechanism consists of an electric jack, not represented on the additional figures, allowing the rotation of plate 2 around the central axis 4, the aforementioned jack advantageously making it possible to control the slope of the aforesaid plate 2. Preferentially, the patient's body is inclined so his feet are directed upward while his head faces down toward the tray 2 horizontally. This conveniently allows a natural extension of the patient's body.

The patient lying on the tilt plate 2 must be bound to said plate 2, so as to avoid sliding out of it. To this end, this table 1 has at least one way to attach the patient's body. Preferably, the retaining means keeps the patient on the table 1 by means of his lower limbs, for example the feet or ankles

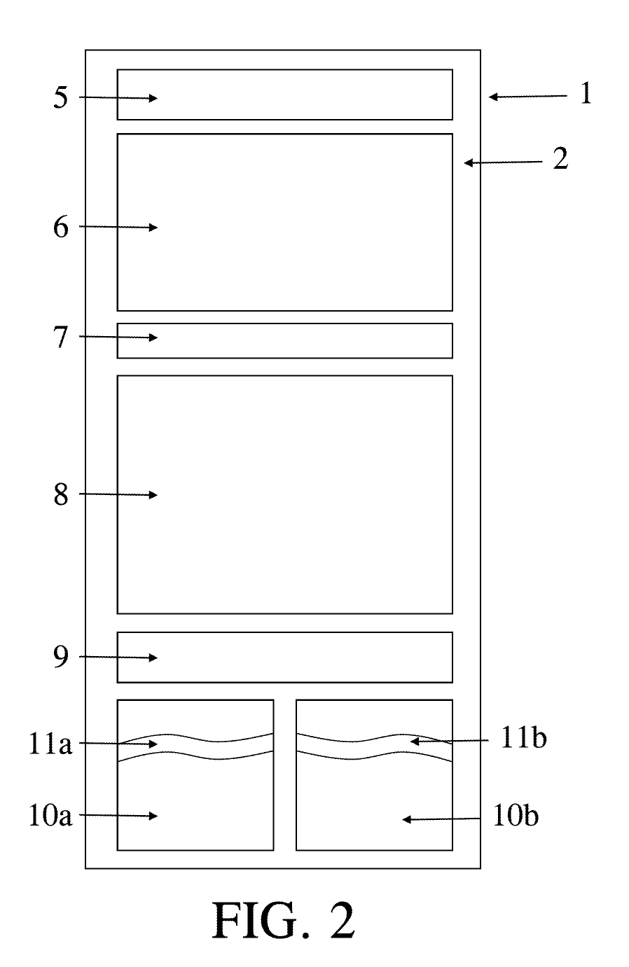

According to the method of realization of the invention as shown schematically on the FIG. 2, these means of withholding consist of straps, shown respectively 11A and 11B, that may maintain each of the two ankles of the patient. Plate 2 of table 1 according to the invention comprises also at least one engine means making it possible to propagate vibrations to at least a part of the aforesaid plate 2, so that at least one part of the body of the patient is subjected to vibrations being able to have a relaxing and/or a therapeutic effect.

Advantageously, the plate 2 of the massage table 1 according to the invention is divided into a plurality of transverse cushions 5, 6, 7, 8, 9, 10. Each of these cushions 5, 6, 7, 8, 9, 10 are adapted to a specific part of the body of the patient lying on said table 1. According to an essential characteristic of the invention, one of the cushions, e.g. cushion 10, is particularly adapted to the ankles and the feet of the patient. Cushion 10 is advantageously activated in vibration by at least one engine means being able to be located under the aforementioned cushion 10, so that the vibrations are propagated to the whole body of the patient by a setting in preliminary vibration of the ankles and feet of the patients.

According to an example of a particular accomplishment of this massage table 1, said cushion 10, adapted to the ankles and feet of the patient, is divided into two juxtaposed portions, 10a and 10b. These two portions, 10a and 10b of the cushion 10, are visible in FIG. 2. In a manner particularly advantageous, it is these two portions 10a and 10b of the cushion 10 that each have a means of withholding the body of the patient, for example in the form of straps 11a and 11b, and maintain the ankles of the patient. Maintaining a lower area of the body is much preferable to withholding by the head, because the latter possibility may give the patient discomfort, such as a feeling of choking Moreover, when the patient is maintained by straps 11a and 11b at the level of his ankles, he can attach himself to plate 2.

Preferably, the two portions 10a and 10b of the cushion 10 initially will propagate the vibrations at the lower zone of the body of the patient, the feet and the ankles, then to the whole body of this one. With this intention, the two portions 10a and 10b are set in vibration by the presence of at least one motor means. Preferentially, each of the aforesaid portions 10a and 10b of cushion 10, adapted to the feet and the ankles of the patient, are associated with a motor means making it possible to generate vibrations and to transmit them to each of the two portions 10a and 10b. These portions can thus vibrate independently from each other.

Preferentially, the motor means makes it possible to propagate the vibrations, at the same time short and according to a raised frequency, to the whole of the body of the patient, from the feet and ankles up of the patient. That advantageously brings a feeling of relaxation and well-being to the patient who is lying on table 1, according to the invention.

According to a mode of particularly advantageous realization of the invention, the vibrating massage table 1 also comprises, besides cushion 10 adapted to the feet and the ankles of the patient: a first cushion 5, adapted to receive the head of the patient and advantageously comprising a cervical support; a second cushion 6 adapted to the thorax of the patient; a third cushion 7 adapted to the lumbar of the patient; a fourth cushion 8 adapted at the same time to the pelvis and thighs of the patient; and a fifth cushion 9, adapted to the calves of the patient.

Preferably, at least one of cushions 5, 6, 7, 8 and 9 is mobile from another one of cushions 5, 6, 7, 8 or 9, for example along a longitudinal axis to plate 2 of table 1. More preferentially still, the four first cushions 5, 6, 7 and 8, respectively adapted to the head, the thorax, the lumbar, the pelvis and thighs of the patient, who are assembled mobile from each other, and along a longitudinal axis to plate 2 of the massage table 1, according to the invention. Preferentially, these four cushions 5, 6, 7 and 8 are mobile by a sliding motion along a rail, or slide, not represented in the figures attached. This characteristic can be advantageous advantageously when the plate 2 of table 1 is tilted and under the pressure of the body of the patient extended on the aforementioned plate 2, such that the cushions 5, 6, 7 and 8 accompany the extension by the body while slipping along the rail. Thus, this permits to prevent various parts of the body of the patient, following the extension of the body due to gravity, from slipping out of the cushions 5, 6, 7 and 8. The body presents innate faculties making it possible to limit this extension.

According to a particular mode of realization, the vibrating massage table 1 according to the invention also includes means of management of the sliding motion, which is not represented in the additional figures. The aforementioned means of management of the sliding motion are preferentially associated to each of the mobile cushions longitudinally, for example the four cushions 5, 6, 7 and 8, such to allow a limitation of the sliding motion of these cushions. The presence of these integrated means makes it possible to manage the sliding motion of the mobile cushions, in particular the cushions 5, 6, 7 and 8, so that they follow the natural movement of the body of the patient at the time of extension upon tilting of the plate 2 of the table 1. The means for controlling the sliding motion are also useful when returning the table 1 to the horizontal position at the end of the session when the patient's body is subjected to compression. Through the action of these means, the compression of the body is smooth.

Thus, vibrating massage table 1, according to the invention, can advantageously combine treatment of the human body by vibrations propagated through the cushion 10 with a greater or lesser inclination of the body, which is made possible by tilting the plate 2 and allowing stretching of the body by gravity. In addition, the longitudinal mobility by sliding motion of the four first cushions 5, 6, 7 and 8 allows a smooth extension of the body by gravity and ensures that this extension does not doesn't lead to the patient's body sliding out of the adapted cushions.

Such an association between the vibrations, propagated from the feet and the ankles, and a variable tilting of plate 2 of table 1 involve a particularly interesting simulation of the decompression of the intervertebral discs. Such a decompression make possible a micro-oxygenation of the intervertebral joints, which is generally accompanied by a decompression of the spinal nerves, which are in particular responsible for the sensitivity and mobility of body parts. Moreover, the vibratory wave propagation from one of the ends of the human body, such as from the feet and the ankles, make it possible to avoid a physiological defensive state of the patient, which can occur, for example, when several parts of the body enter in vibration simultaneously or when the vibrations are transmitted via the head of the patient.

The vibrating massage table 1, according to the invention can advantageously be used for therapeutic purposes; indeed, association between the vibrations and the stretching of the body by gravity, accompanied by a movement of the cushions, for example the cushions 5, 6, 7, and 8, allows notably to treat problems of protrusion formed in the intervertebral discs, from simple protrusion to an herniated disc.

According to another interesting application, the present table of vibrating massage table 1 can be used before and/or after a physical effort more or less intense. The characteristics of the said table 1 will allow a relaxing effect particularly interesting for the body of the patient treated, and notably at the level of the musculoskeletal complex. Thus, in a manner particularly interesting, the vibrating massage table 1 according to the invention presents a preventive application and a curative application for a patient.

Of course, the invention is not limited to the illustrated and previously described examples, but can present variants and modifications without going outside the framework of the invention.

1. A vibrating massage table comprising:
at least one foot support on which rests a plate tilting around a central axis and allowing an incline of a patient on the vibrating massage table so that feet of the patient are placed on a level higher than a head of the patient, the plate comprising:
at least one engine means for propagating vibrations and at least one means for restraining the patient,
wherein the plate is longitudinally subdivided into a plurality of transverse cushions,
wherein at least a portion of the plurality of transverse cushions are adapted to a part of a body of the patient,
wherein one of the plurality of transverse cushions is adapted to ankles and the feet of the patient and is activated by the at least one engine means to vibrate from the ankles and the feet to the body of the patient.

2. The vibrating massage table of claim 1, wherein the one of the plurality of transverse cushions is divided into two juxtaposed portions each having a means for retaining the ankles and/or the feet of the patient, wherein said portions vibrate by at least one motor means.

3. The vibrating massage table of claim 2, wherein the plurality of transverse cushions include:
a first cushion to receive the head of the patent and provide a cervical support;
a second cushion to receive a thorax of the patient
a third cushion to receive a lumbar of the patient;
a fourth cushion to receive a pelvis and thighs of the patient;
a fifth cushion to receive calves of the patient.

4. The vibrating massage table of claim 3, wherein at least one of the plurality of transverse cushions is mobile in relation to at least another one of the plurality of transverse cushions along a longitudinal axis of the plate.

5. The vibrating massage table of claim 1, wherein the plurality of transverse cushions are mobile in relation to one another by sliding alongside a longitudinal axis of the plate.

6. The vibrating massage table of claim 5, wherein the plurality of transverse cushions are mobile by sliding motion along a rail located approximately at the center of the plate.

7. The vibrating massage table of claim 6, wherein the plate comprises means for managing the sliding motion to limit the sliding motion of the plurality of transverse cushions.

8. The vibrating massage table claim 2, wherein at least one of the plurality of transverse cushions is mobile in relation to at least another one of the plurality of transverse cushions along a longitudinal axis of the plate.

9. The vibrating massage table claim 1, wherein at least one of the plurality of transverse cushions is mobile in relation to at least another one of the plurality of transverse cushions along a longitudinal axis of the plate.

10. The vibrating massage table of claim 1, wherein the plurality of transverse cushions include:
a first cushion to receive the head of the patent and provide a cervical support;
a second cushion to receive a thorax of the patient a third cushion to receive a lumbar of the patient;
a fourth cushion to receive a pelvis and thighs of the patient;
a fifth cushion to receive calves of the patient.

11. The vibrating massage table of claim 10, wherein at least one of the plurality of transverse cushions is mobile in relation to at least another one of the plurality of transverse cushions along a longitudinal axis of the plate.
